(19) United States
(12) Patent Application Publication
(10) Pub. No.: US 2021/0249177 A1
(43) Pub. Date: Aug. 12, 2021

(54) SHIELDING FOR A LAMINATE INDUCTOR COIL

(71) Applicant: QUALCOMM Incorporated, San Diego, CA (US)

(72) Inventors: Chunhu ZHANG, San Diego, CA (US); Ravi Kiran CHALLA, San Diego, CA (US); Daniel Daeik KIM, San Diego, CA (US); Chandra Sekhar Reddy KAIPA, San Diego, CA (US)

(21) Appl. No.: 16/788,484

(22) Filed: Feb. 12, 2020

(51) Int. Cl. H01F 27/28; H01Q 7/04; H01F 41/04

(52) U.S. Cl. CPC H01F 27/2804; H01Q 7/04; H01F 2027/2809; H01F 41/041; H01F 27/2885

(57) ABSTRACT

Certain aspects of the present disclosure generally relate to an electronic device having an inductive element made up of a plurality of metal layers including a metal shielding layer with one or more electrically floating metal pieces. One example electronic device has a plurality of metal layers that generally includes a bottom metal layer, one or more middle metal layers disposed above the bottom metal layer, wherein at least one of the middle layers comprises a coil, and a top metal layer disposed above the one or more middle metal layers. At least one of the bottom metal layer or the top metal layer comprises a shield layer. At least a first portion of a first region of the shield layer overlying or underlying the coil comprises one or more metal pieces that are electrically floating and are disconnected from the shield layer.

### TECHNICAL FIELD

Certain aspects of the present disclosure generally relate to electronic components and, more particularly, to electrical shielding for a laminate inductor coil.

### BACKGROUND

Computing devices have become increasingly common in modern society. Amongst the more common computing devices are mobile phones. While such devices may initially have started out as simple devices that allowed audio communication through the Public Land Mobile Network (PLMN) to the Public Standard Telephone Network (PSTN), they have evolved into smartphones capable of supporting full multimedia experiences, as well as supporting multiple wireless protocols. Even within the cellular wireless protocols, mobile phone radios have developed into highly complex, multi-band, and multi-standard designs that often have multiple radio frequency (RF) signal chains.

Such devices may include a radio frequency (RF) front-end (RFFE), including a variety of front-end devices, such as power amplifiers (PAs), low-noise amplifiers (LNAs), filters, switches, power management modules, inductors (e.g., laminate coil inductors), tuning circuits, and sensors. These functions may be located either in separate devices or integrated into a single device, depending on the application. The trend in mobile radio communications is towards complex multi-radio systems composed of several parallel transceivers.

### SUMMARY

Certain aspects of the present disclosure are generally directed to an electronic device. The electronic device generally includes a plurality of metal layers comprising a bottom metal layer; one or more middle metal layers disposed above the bottom metal layer, wherein at least one of the middle layers comprises a coil; and a top metal layer disposed above the one or more middle metal layers, wherein: at least one of the bottom metal layer or the top metal layer comprises a shield layer; and at least a first portion of a first region of the shield layer overlying or underlying the coil comprises one or more metal pieces that are electrically floating and are disconnected from the shield layer.

Certain aspects of the present disclosure are generally directed to a method for fabricating an electronic device having a plurality of metal layers. The method generally includes forming a bottom metal layer; forming one or more middle metal layers disposed above the bottom metal layer, wherein at least one of the middle layers comprises a coil; and forming a top metal layer disposed above the one or more middle metal layers, wherein: at least one of the bottom metal layer or the top metal layer comprises a shield layer; and at least a first portion of a first region of the shield layer overlying or underlying the coil comprises one or more metal pieces that are electrically floating and are disconnected from the shield layer.

### BRIEF DESCRIPTION OF THE DRAWINGS

So that the manner in which the above-recited features of the present disclosure can be understood in detail, a more particular description, briefly summarized above, may be by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIGS. 1A and 1B illustrate a cross-sectional view and a top view, respectively, of a conventional laminated inductor coil.

FIG. 2 illustrates a perspective view of an electronic device including a metal shielding layer with electrically floating metal pieces, according to certain aspects presented herein.

FIG. 3A illustrates another example metal shielding layer with electrically floating metal pieces, according to certain aspects presented herein.

FIG. 3B illustrates another example metal shielding layer including a grid array of metal pieces connected by traces, according to certain aspects presented herein.

FIG. 4 is a flow diagram illustrating example operations for fabricating an electronic device having a plurality of metal layers including a metal shielding layer with electrically floating metal pieces, in accordance with certain aspects of the present disclosure.

### DETAILED DESCRIPTION

Certain aspects of the present disclosure are generally directed to an electronic device, and more specifically to electrical shielding for laminated inductor coils. The electronic device generally includes a coil and at least one shield layer overlying and/or underlying the coil, the shield layer comprising one or more metal pieces that are electrically floating and are disconnected from the shield layer.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

Certain terminology may also be used in the following description for the purpose of reference only, and thus are not intended to be limiting. For example, terms such as “upper,” “lower,” “above,” “below,” “bottom,” and “top” refer to directions in the drawings to which reference is made. Terms such as “front,” “back,” “rear,” and “side” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

### Example Shielding for a Laminate Inductor Coil

Wireless devices may include a radio frequency front-end (RFFE), which may include one or more transmit (TX) chains and or one or more receive (RX) chains. In certain cases, RFFEs may include one or more inductors within tuning circuits and/or filters between antennas of the one or more TX chains and one or more RX chains. In certain cases, these inductors may be implemented as laminated coil inductors.

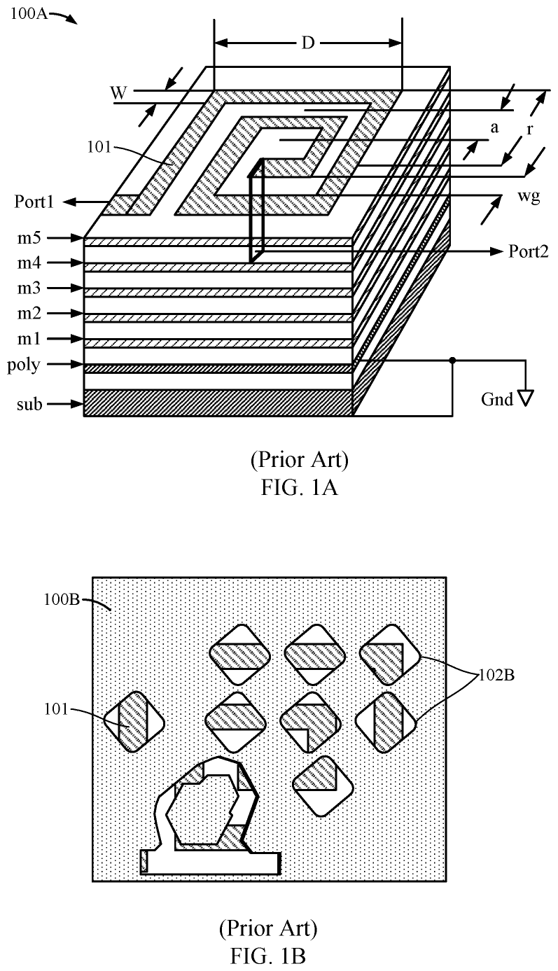

FIG. 1A illustrates a perspective view of a conventional laminate 100A having an inductor coil 101 (e.g., of a RFFE). Integrated inductors coils may occupy large amounts of chip area to achieve sufficient inductance values for RF designs. One such design includes an on-chip square spiral inductor, which, as illustrated, may comprise a plurality of metal layers (e.g., m2-m5 plus shielding layers m1 and m6). The inductor coil 101 may be made by making square shape windings with one or more turns in one or more metal layers of the process. The inductance value for the structure may depend on the metal linewidth (w), the gap between metal lines (wg), the outermost spiral radius (r), and the average spiral radius (a).

There are several design considerations that may be taken into account when designing these laminate inductor coils, such as quality factor (Q), area occupied, metal density, potential coupling with adjacent structures, disruption to ground (GND) scheme, etc. A conventional laminate inductor coil design typically covers the inductor coil(s) on the top and bottom with solid metal shielding layers to avoid coupling and GND disruption. However, such shielding metal layer designs typically degrade the Q associated with the inductor coil. The Q is a dimensionless number based on the bandwidth of a resonator circuit with the inductor coil, relative to its center frequency, and typically indicates performance of the inductor coil in the resonator circuit.

FIG. 1B is a top view of a conventional metal shielding layer 100B for a laminated inductor coil. As noted above, the metal shielding layer 100B may be disposed on top of or under the laminate inductor coil 101 to prevent coupling electrical interference to or from the coil and avoid GND disruption. In some cases, holes 102B may be included in the metal shielding layer 100B to reduce the metal density of the shielding layer. However, the holes 102B are not designed to improve the Q of the laminate inductor coil 100A and, thus, such laminate inductors coil designs typically cannot provide a sufficient balance between Q and other design considerations (e.g., area occupied, metal density, potential coupling with adjacent structures, and disruption to ground (GND) scheme).

Therefore, aspects of the present disclosure provide techniques for improving the Q associated with laminate inductor coils while balancing the desire to reduce coupling, GND disruption, and metal density of the shielding layer. For example, in some cases, techniques presented herein involve creating a large-area cutout region in the metal shielding layer on top of and/or below the laminate coil. Electrically isolated/floating metal plates (or pieces with other shapes) may then be arranged in the cutout region of the metal shielding layer. These floating metal pieces greatly enhance the laminate coil Q while reducing the metal density and preventing magnetic field coupling with surrounding structures.

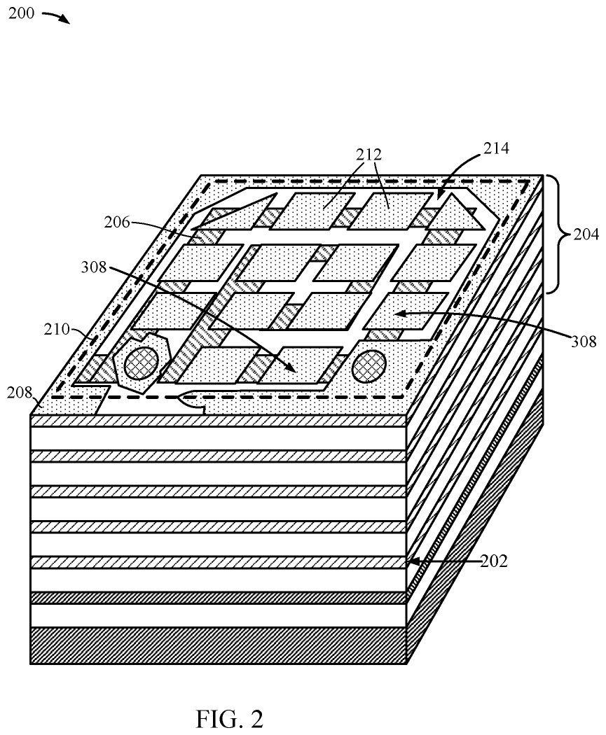

FIG. 2 illustrates a perspective view of an electronic device 200 including a metal shielding layer with electrically floating metal pieces, according to certain aspects presented herein. For example, as illustrated, the electronic device 200 may include a bottom metal layer 202 and one or more middle metal layers 204 disposed above the bottom metal layer 202. In some cases, at least one of the middle layers 204 may comprise a coil 206, such as the laminate inductor coil 101. In some cases, the coil 206 may comprise an antenna coil for communication.

Additionally, as illustrated, the electronic device 200 may include a top metal layer 208 disposed above the one or more middle metal layers 204. In some cases, at least one of the bottom metal layer 202 or the top metal layer 208 comprises a shield layer. For ease of understanding, references to “the shield layer” herein may refer to the top metal layer 208 or the bottom metal layer 202.

According to aspects, as illustrated, at least a first portion of a first region 210 of the shield layer (e.g., top metal layer 208) overlying or underlying the coil 206 may comprise one or more metal pieces 212 (also, referred to as metal plates) that are electrically floating and are disconnected from the shield layer, forming a grid pattern above or below the coil 206. For example, as illustrated, the one or more metal pieces 212 are separated by a space 214 and not connected to the shield layer. The term “electrically floating” is intended to mean that the one or more metal pieces 212, as illustrated, are separated from (e.g., by space 214) and not electrically connected to electrical ground or another power rail, whereas the shielding layer may be connected to ground. In other words, the one or more metal pieces 212 are electrically isolated from the shielding layer and are not connected to ground.

It should be noted that the techniques described above with respect to the top metal layer 208 may also be applicable to the bottom metal layer 202. In other words, the bottom metal layer 202 may additionally or alternatively comprise a similar shield layer as the top metal layer 208. For example, in some cases, the top metal layer 208 comprises a first shield layer, and the bottom metal layer 202 comprises a second shield layer. Accordingly, in some cases, the first shield layer comprises a region of the first shield layer overlying the coil 206, and the second shield layer comprises a region of the second shield layer underlying the coil. Further, at least one of the region of the first shield layer or the region of the second shield layer comprises one or more metal pieces (e.g., metal pieces 212) that are electrically floating and are disconnected from at least one of the first shield layer or the second shield layer.

Additionally, in some cases, the one or more middle metal layers 204 may comprise another coil (not illustrated). At least a portion of a second region of the shield layer overlying or underlying the other coil comprises one or more additional metal pieces that, in some cases, are electrically floating and are disconnected from the shield layer.

According to aspects, by having the one or more metal pieces 212 electrically floating and not connected to the shielding layer or ground, the Q associated with the coil 206 may be greatly enhanced, while reducing the metal density and preventing a magnetic field produced by the coil 206 from coupling with surrounding structures. For example, by using a shielding layer with electrically floating metal pieces, the Q of the coil 206 is, in some cases, able to achieve approximately a 50% higher Q in the 600 MHz to 1000 MHz frequency range as compared to the design of the conventional metal shielding layer 100B. Additionally, the shielding layer with electrical floating metal pieces is able to improve dissipative loss (e.g., by about 0.12 dB) and TX/RX locus size.

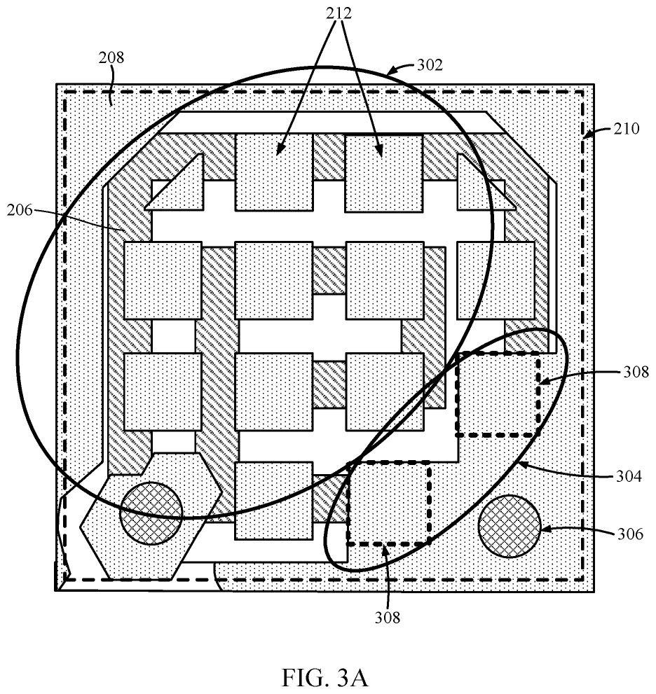

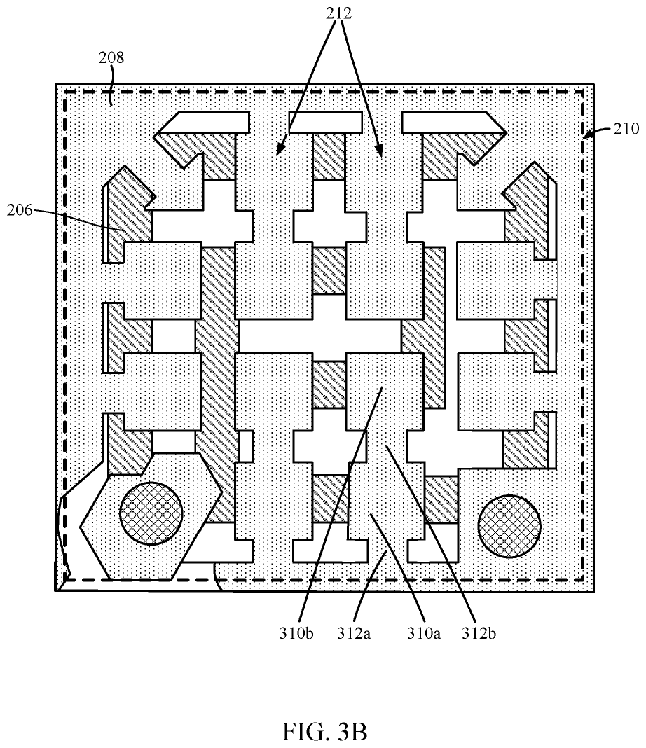

In some cases, however, isolation may be degraded slightly (e.g., by about 6 dB) due to disruption to the ground scheme. Thus, FIG. 3A illustrates, a further improvement on the shield layer of the electronic device 200 illustrated in FIG. 2. For example, as illustrated in FIG. 3A, one or more metal pieces 212 may be disposed in at least a first portion 302 of a first region 210 of the shield layer overlying (e.g., the top metal layer 208) or underlying (e.g., the bottom metal layer 202) the coil 206. However, to reduce ground disruption, a second portion 304 of the first region 210 of the shield layer overlying or underlying the coil may be coupled to the shield layer. For example, as illustrated, the second portion 304 may comprise the metal pieces 308 that may be coupled to the top metal layer 208 (which were electrically floating in FIG. 2, as illustrated). According to aspects and as illustrated, the second portion 304 may be located adjacent to a solder bump 306 corresponding to a ground pin and coupled to a reference potential node (e.g., ground) for the electronic device. According to aspects, by coupling the metal pieces 308 to the shield layer by the solder bump 306 corresponding to the ground pin, the ground scheme may be improved by reducing the isolation degradation (e.g., from about 6 dB to 3 dB) while preserving the improved Q and locus size.

FIG. 3B illustrates another example metal shielding layer including a grid array of metal pieces connected by traces, according to certain aspects presented herein. For example, as illustrated, in some cases, one or more metal pieces 212 may be disposed in a grid array of a first region 210 of the shield layer overlying (e.g., the top metal layer 208) or underlying (e.g., the bottom metal layer 202) the coil 206. As illustrated, the one or more metal pieces 212 may be coupled to the shield layer via one or more traces. For example, as illustrated, the one or more metal pieces 212 may include a first metal plate 310a and a second metal plate 310b. Further, as illustrated, the first metal plate 310a may be coupled to the shield layer by a first metal trace 312a. Additionally, in some cases, the second metal plate 210b may be coupled to the first metal plate by a second metal trace 312b. Although two metal plates 310a, 310b and two traces 312a, 312b are illustrated in the shield layer of FIG. 3B, it is to be understood that the shield layer may include more or less than two metal plates and more or less than two traces. Furthermore, for certain aspects, one or more of the metal plates 310a, 310b may be electrically floating.

### Example Fabrication of Shielding for a Laminate Inductor Coil

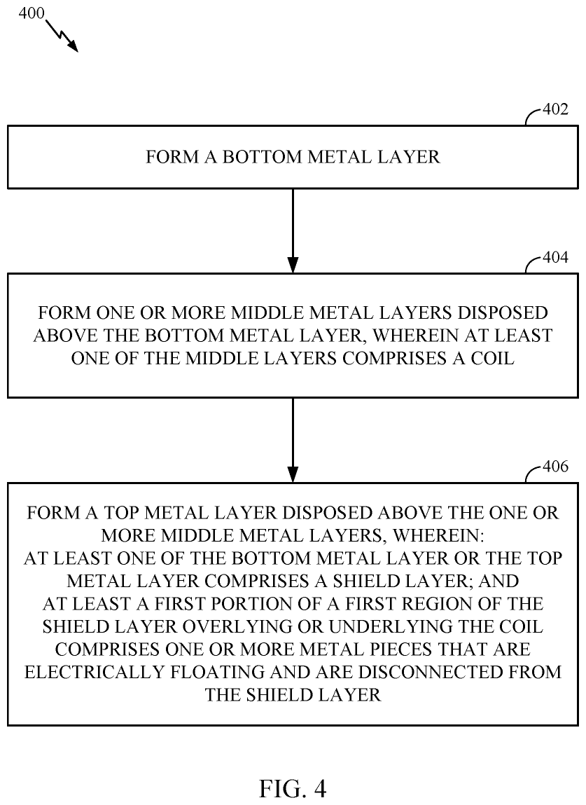

FIG. 4 is a flow diagram illustrating example operations 400 for fabricating an electrical device having a plurality of metal layers, including a shield layer with one or more electrically floating metal pieces, in accordance with certain aspects of the present disclosure. The operations 400 may be performed, for example, by a semiconductor manufacturing or processing facility.

The operations 400 begin, at block 402, with the semiconductor manufacturing/processing facility forming a bottom metal layer (e.g., bottom metal layer 202).

At block 404, the semiconductor manufacturing/processing facility forms one or more middle metal layers (e.g., middle metal layers 204) disposed above the bottom metal layer. At least one of the middle layers comprises a coil (e.g., coil 206). In some cases, the coil comprises an antenna coil for communication.

At block 406, the semiconductor manufacturing/processing facility forms a top metal layer (e.g., top metal layer 208) disposed above the one or more middle metal layers. In this case, at least one of the bottom metal layer or the top metal layer comprises a shield layer, and at least a first portion (e.g., first portion 302) of a first region (e.g., first region 210) of the shield layer overlying or underlying the coil comprises one or more metal pieces (e.g., metal pieces 212) that are electrically floating and are disconnected from the shield layer. In some cases, the one or more metal pieces comprise one or more metal plates.

In some cases, the semiconductor manufacturing/processing facility forms the shield layer such that the one or more metal pieces form a grid pattern above or below the coil.

In some cases, the semiconductor manufacturing/processing facility forms the shield layer such that at least a second portion (e.g., second portion 304) of the first region of the shield layer overlying or underlying the coil is coupled to the shield layer. In some cases, the semiconductor manufacturing/processing facility forms the shield layer such that the at least the second portion is coupled to a reference potential node for the electronic device. In some cases, the semiconductor manufacturing/processing facility forms the shield layer such that the at least the second portion is located adjacent to a solder bump (e.g., solder bump 306) corresponding to a ground pin.

In some cases, the semiconductor manufacturing/processing facility forms the one or more middle metal layers such that the one or more middle layers comprise another coil. Additionally, in some cases, the semiconductor manufacturing/processing facility forms the shield layer such that at least a portion of a second region of the shield layer overlying or underlying the other coil comprises one or more additional metal pieces. Further, in some cases, the semiconductor manufacturing/processing facility forms the shield layer such that one or more additional metal pieces are electrically floating and are disconnected from the shield layer. Further, in some cases, the semiconductor manufacturing/processing facility forms the shield layer such that the one or more additional metal pieces are coupled to the shield layer. Further, in some cases, the semiconductor manufacturing/processing facility forms the shield layer such that each of the one or more additional metal pieces comprises a first metal plate (e.g., first metal plate 310a) coupled to the shield layer by a first metal trace (e.g., first metal trace 312a). Further, in some cases, the semiconductor manufacturing/processing facility forms the shield layer such that each of the one or more additional metal pieces further comprises a second metal plate (e.g., second metal plate 310b) coupled to the first metal plate by a second metal trace (e.g., second metal trace 312b).

In some cases, the semiconductor manufacturing/processing facility forms the top metal layer (e.g., top metal layer 208) such that the top metal layer comprises a first shield layer, the first shield layer comprising a region of the first shield layer overlying the coil (e.g., coil 206). In some cases, the semiconductor manufacturing/processing facility forms the bottom metal layer (e.g., bottom metal layer 202) such that the bottom metal layer comprises a second shield layer comprising a region of the second shield layer underlying the coil. Further, in some cases, the semiconductor manufacturing/processing facility forms the top metal layer and/or the bottom metal layer such that at least one of the region of the first shield layer or the region of the second shield layer comprises one or more metal pieces that are electrically floating and are disconnected from at least one of the first shield layer or the second shield layer, for example, as illustrated in FIG. 3A.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B and object B touches object C, then objects A and C may still be considered coupled to one another—even if objects A and C do not directly physically touch each other. For instance, a first object may be coupled to a second object even though the first object is never directly physically in contact with the second object. The terms “circuit” and “circuitry” are used broadly and intended to include both hardware implementations of electrical devices and conductors that, when connected and configured, enable the performance of the functions described in the present disclosure, without limitation as to the type of electronic circuits.

The apparatus and methods described in the detailed description are illustrated in the accompanying drawings by various blocks, modules, components, circuits, steps, processes, algorithms, etc. (collectively referred to as “elements”). These elements may be implemented using hardware, for example.

One or more of the components, steps, features, and/or functions illustrated herein may be rearranged and/or combined into a single component, step, feature, or function or embodied in several components, steps, or functions. Additional elements, components, steps, and/or functions may also be added without departing from features disclosed herein. The apparatus, devices, and/or components illustrated herein may be configured to perform one or more of the methods, features, or steps described herein.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover at least: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. An electronic device having a plurality of metal layers comprising:
a bottom metal layer;
one or more middle metal layers disposed above the bottom metal layer, wherein at least one of the middle layers comprises a coil; and
a top metal layer disposed above the one or more middle metal layers, wherein:
at least one of the bottom metal layer or the top metal layer comprises a shield layer; and
at least a first portion of a first region of the shield layer overlying or underlying the coil comprises one or more metal pieces that are electrically floating and are disconnected from the shield layer.

2. The electronic device of claim 1, wherein the one or more metal pieces form a grid pattern above or below the coil.

3. The electronic device of claim 1, wherein at least a second portion of the first region of the shield layer overlying or underlying the coil is coupled to the shield layer.

4. The electronic device of claim 3, wherein the at least the second portion is coupled to a reference potential node for the electronic device.

5. The electronic device of claim 3, wherein the at least the second portion is located adjacent to a solder bump corresponding to a ground pin.

6. The electronic device of claim 1, wherein the coil comprises an antenna coil.

7. The electronic device of claim 1, wherein the one or more metal pieces comprise one or more metal plates.

8. The electronic device of claim 1, wherein:
the one or more middle metal layers comprise another coil; and
at least a portion of a second region of the shield layer overlying or underlying the other coil comprises one or more additional metal pieces.

9. The electronic device of claim 8, wherein the one or more additional metal pieces are electrically floating and are disconnected from the shield layer.

10. The electronic device of claim 8, wherein the one or more additional metal pieces are coupled to the shield layer.

11. The electronic device of claim 10, wherein each of the one or more additional metal pieces comprises a first metal plate coupled to the shield layer by a first metal trace.

12. The electronic device of claim 11, wherein each of the one or more additional metal pieces further comprises a second metal plate coupled to the first metal plate by a second metal trace.

13. The electronic device of claim 1, wherein:
the top metal layer comprises a first shield layer;
the bottom metal layer comprises a second shield layer;
the first shield layer comprises a region of the first shield layer overlying the coil;
the second shield layer comprises a region of the second shield layer underlying the coil; and
at least one of the region of the first shield layer or the region of the second shield layer comprises one or more metal pieces that are electrically floating and are disconnected from at least one of the first shield layer or the second shield layer.

14. A method for fabricating an electronic device having a plurality of metal layers, comprising:
forming a bottom metal layer;
forming one or more middle metal layers disposed above the bottom metal layer, wherein at least one of the middle layers comprises a coil; and
forming a top metal layer disposed above the one or more middle metal layers, wherein:
at least one of the bottom metal layer or the top metal layer comprises a shield layer; and
at least a first portion of a first region of the shield layer overlying or underlying the coil comprises one or more metal pieces that are electrically floating and are disconnected from the shield layer.

15. The method of claim 14, wherein the one or more metal pieces form a grid pattern above or below the coil.

16. The method of claim 14, wherein at least a second portion of the first region of the shield layer overlying or underlying the coil is coupled to the shield layer.

17. The method of claim 16, wherein the at least the second portion is coupled to a reference potential node for the electronic device.

18. The method of claim 16, wherein the at least the second portion is located adjacent to a solder bump corresponding to a ground pin.

19. The method of claim 14, wherein:
the one or more middle metal layers comprise another coil;
at least a portion of a second region of the shield layer overlying or underlying the other coil comprises one or more additional metal pieces; and
the one or more additional metal pieces are electrically floating and are disconnected from the shield layer.

20. The method of claim 14, wherein:
the top metal layer comprises a first shield layer;
the bottom metal layer comprises a second shield layer;
the first shield layer comprises a region of the first shield layer overlying the coil;
the second shield layer comprises a region of the second shield layer underlying the coil; and
at least one of the region of the first shield layer or the region of the second shield layer comprises one or more metal pieces that are electrically floating and are disconnected from at least one of the first shield layer or the second shield layer.
